(19) United States
(12) Patent Application Publication
(10) Pub. No.: US 2020/0039676 A1
(43) Pub. Date: Feb. 6, 2020

(54) SYSTEM AND METHODS FOR AUTOMATIC LABELING OF ARTICLES OF ARBITRARY SHAPE, SIZE AND ORIENTATION

(71) Applicant: The Recon Group LLP, Miami, FL (US)

(72) Inventor: Sender Shamiss, Sunny Isles, FL (US)

(73) Assignee: The Recon Group LLP, Miami, FL (US)

(21) Appl. No.: 16/053,018

(22) Filed: Aug. 2, 2018

(51) Int. Cl. B65C 9/00; G06F 7/00; B65B 15/00; B65B 59/00; B67B 1/00; B25J 9/00

(52) U.S. Cl. CPC B65C 9/00; G06F 7/00; B65B 15/00; G09F 5/04; B67B 1/00; B25J 9/0093; B65B 59/00

(57) ABSTRACT

The present disclosure provides an improved system and related methods for automating the sizing and labeling of articles of arbitrary shape, size and orientation, whether still or moving. The system comprises a detection and interrogation zone, one or more proximity sensors, one or more interrogation devices, a processor, a controller, a labeling device, and an electromechanical label applicator arm. Detection of an article by a proximity sensor triggers an interrogation device to interrogate the detection and imaging zone for one or more observable properties when the article is located therein. Analysis of the interrogation data yields the height of the article. Combined with a conveyor rate, article height determines the signals sent to the controller, which commands when and how far a label applicator arm should extend from the labeling apparatus to label the article.

### FIELD OF THE INVENTION

The present disclosure relates to article measurement and identification, and more particularly systems and methods for automatic labeling of articles at rest or in motion.

### BACKGROUND OF THE INVENTION

Labeling is a common step in the processing of articles in diverse fields for diverse purposes, for example, managing warehouse space and inventory. Article size can have a marked impact on the approach to, or outcome of, an article labeling protocol. Sizing and labeling can be distinct, but also sequential and complementary, steps of a complex materials processing protocol. Purposes of article labeling can include indicating contents, enabling tracking, specifying destination and facilitating sorting, among others. For example, singulated articles on a conveyor belt can be sized and labeled in preparation for a binary sortation process based on girth.

Different size-determination systems and related methods are used to determine different article size metrics. Some such systems include one or more optical size- or distance-measurement devices, for example, a camera or an interferometer. A camera can be used to capture images of an article when one or more length indicators are present in the field of view, or length indicators can be added to images after capture. Length scales can in either case be configured for facilitating the determination of one or more spatial dimensions of the article, for example, length and width.

Automating determination of one or more spatial dimensions of an article can comprise automating image capture and processing and, often, automating article singulation and conveyance to a size-determination site. The approach can be useful, but in general it will be limited by a need to image each article from a plurality of perspectives relative to a support on which the articles are placed and/or conveyed for size interrogation.

The difficulty of automating size measurement will depend in general on article shape and orientation. Automation will be straightforward when shape and orientation are uniform, as in the case of aligned cuboidal boxes of different combinations of length, width and height. Automation will be considerably harder for articles of arbitrary size, shape and orientation, even if the articles are aligned and singulated before measurement and the sole observable quantity of interest is height. Accurate height mensuration will be an even greater challenge for odd-sized articles in motion.

Automated article labeling can be desirable for many reasons. Examples include improving or maintaining product appearance standards and controlling manufacturing costs. Another example is providing a means of integrating diverse aspects of inventory management. It can be straightforward to automate article labeling. The process will be simple and highly repetitive for some kinds of article, for example, articles of uniform size, shape and orientation on a conveyor. Articles of arbitrary size, shape and orientation, by contrast, can pose a considerable technical challenge for label application. Labeling such articles will be difficult, even if all are singulated in an upstream process, the conveyor rate is fixed, and the spacing between articles is constant. The complexity of a labeling process will obviously be greater if the separation distance between articles is variable.

For such reasons and others, it is desirable to develop systems and methods for the automatic sizing and labeling of articles of arbitrary size, shape and orientation. Despite advances in this area, further improvements are possible.

### SUMMARY OF THE INVENTION

In view of the foregoing, it is an object of the present disclosure to provide an improved system and related methods for automatic sizing and labeling of articles of arbitrary shape, size and orientation, whether still or moving.

In one aspect of the present invention, the system comprises an interrogation system, a processor and a labeling system. The interrogation system is configured for capturing one or more sets of interrogation data pertaining to an article and sending the data to a processor. The processor is configured for receiving the captured data from the interrogation system, calculating physical properties of the article based on the received data, and sending corresponding data to an article labeling system. The labeling system is configured for receiving the corresponding data from the processor and applying a label to the surface of the article.

In another aspect of the present invention, the interrogation system further includes a detection and interrogation zone defined by a predetermined volume, one or more proximity sensors configured for detecting the article at one or more locations in the detection and interrogation zone, and one or more interrogation devices configured for interrogating for physical properties of the detection and imaging zone upon detection of the article. Each proximity sensor is configured for detecting the article independent of the other proximity sensors and triggering a respective interrogation device, and each interrogation device is configured for interrogating one or more times for one or more predetermined physical properties of the detection and interrogation zone when the article is located therein.

In yet another aspect of the present invention, the processor is configured for analyzing one or more sets of interrogation data pertaining to the article, calculating one or more physical quantities, including the height of the article, and sending signals related to the height and rate of motion of the article to the controller.

In still another aspect of the present invention, the labeling system further comprises a controller configured for receiving signals from the processor and sending commands to one or more labeling devices configured for actuating an electromechanical label applicator arm based on commands received from the controller. The label applicator arm is configured to extend at a first specified time and to retract at a second specified time, the times being determined by the height and rate of motion of the article.

According to a first embodiment of the present invention, a method for the automatic sizing of an article of arbitrary size, shape and orientation includes one or more proximity sensors detecting an article in a detection and interrogation zone. Detection triggers one or more interrogation devices to interrogate for one or more predetermined observable properties of the detection and imaging zone, one or more times at a fixed rate, and detection determines the locus of the article at the respective time point. The one or more interrogation devices can include a camera configured for its optical axis to pass through the detection and interrogation zone. The method further includes the one or more interrogation devices transferring to a processor the results of at least one interrogation of observable properties of the detection and imaging zone, and the processor analyzing the results of the one or more interrogations and calculating related physical quantities. These quantities can include the height of the article in the detection and interrogation zone. Article height can be represented in standard units of measure.

In an aspect of the present invention, the system comprises one or more labeling devices configured for applying a label on the surface of an article, regardless of its size, shape or orientation. Each of the one or more labeling devices can comprise an extensible electromechanical label applicator arm capable of responding to commands from a controller and displaying repetitive motion. The label applied by the electromechanical label applicator arm to the surface of the article can be adhesive and article-specific. The article itself, however, is not part of the system.

In another aspect of the present invention, the system comprises a controller configured for receiving from a processor data pertaining to physical properties of an article and sending to one or more labeling devices one or more commands pertaining to a labeling process involving the article. The one or more commands can include a command to actuate an electromechanical label applicator arm to affix a label on the surface of the article. The success of the label application process can depend on adequate control over the motion of the label applicator arm and the time and space coordinates of the article.

In yet another aspect of the present invention, the system comprises a conveyor configured for satisfying logistical constraints of an article-labeling process. The constraints will include the time and space coordinates of an article to be labeled and a label-applying function of one or more labeling devices. The conveyor can be a linear conveyor, and it can convey articles deposited thereon at a constant rate.

According to a second embodiment of the present invention, a method for the automatic labeling of articles of arbitrary shape, size and orientation, whether at rest or in motion, includes one or more labeling devices, a controller and a conveyor. The conveyor can be configured for moving articles from a remote location to at least one of the one or more labeling devices. The controller can be configured for receiving data from a processor regarding physical properties of an article and sending commands to the labeling device pertaining to labeling the article. The labeling device can be configured for receiving commands from the controller regarding the article and actuating the extensible electromechanical label applicator arm so that a label is applied to the article.

In an aspect of the present invention, the system comprises two sub-systems, one for automatic sizing and one for automatic labeling of articles of arbitrary shape, size and orientation, whether at rest or in motion. The size-determining and labeling sub-systems are linked by a processor that can receive data from the sizing function, send corresponding commands to the labeling function, or a controller thereof, and thus coordinate the labeling of articles of arbitrary shape, size and orientation. The processor can coordinate a method for the automatic sizing and a method for the automatic labeling of articles by receiving data regarding the size of an article and signaling a controller to command a labeling device to apply a label to the article, unifying the two methods in a single complex process.

These and other objects, aspects and advantages of the present invention will be better appreciated in view of the drawings and following detailed description of preferred embodiments.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a representative depiction of one embodiment of the present invention, a system for the automatic sizing and labeling of an article of arbitrary size, shape and orientation;

FIG. 2 is a representative depiction of one embodiment of the present invention, a system for the automatic sizing and labeling of an article of arbitrary size, shape and orientation, emphasizing key distances;

FIG. 3 is a flowchart of a method involving the automatic article sizing sub-system of the present invention; and

FIG. 4 is a flowchart of a method involving the automatic article labeling sub-system of the present invention.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

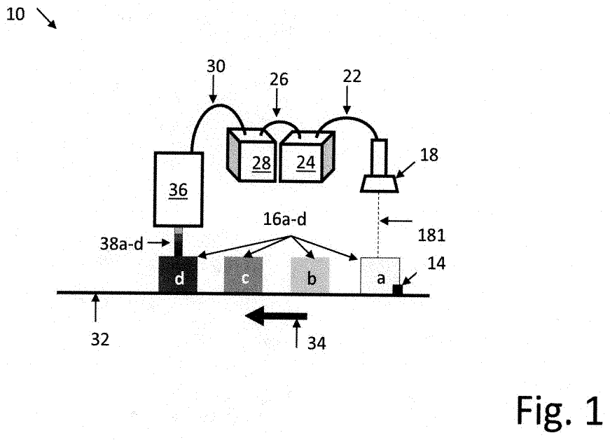

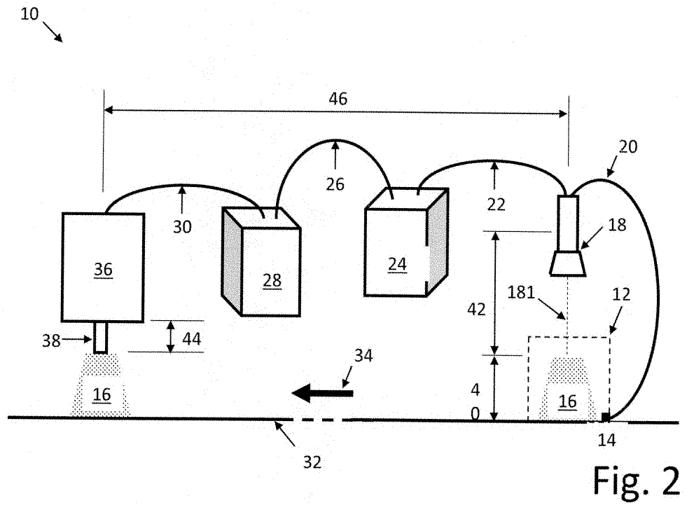

Referring to FIGS. 1 and 2, according to one embodiment of the present invention, a system 10 for automatic determination of article size includes: a detection and interrogation zone 12 configured for having a predetermined volume and shape; one or more proximity sensors 14 configured for detecting the presence of an article 16 in the detection and interrogation zone 12; each of the one or more proximity sensors 14 being further configured for communicating with a respective interrogation device 18 via an electrical connection 20; the one or more interrogation devices 18 being configured for interrogating one or more times for one or more observable quantities of the detection and interrogation zone 12 when an article 16 is detected therein by at least one proximity sensor 14 and for transferring the data acquired in the one or more interrogations to a processor 24; the processor 24 being configured for communicating with the one or more interrogation devices 18 via respective electrical connections 22 and for processing the data received from the one or more interrogation devices 18 by analyzing the results of the one or more interrogations for one or more observable properties and calculating from these properties the height of the article 16.

In the embodiment of the present invention shown in FIG. 2, a detection and interrogation zone 12 is cuboidal. An arrow 34 indicates that a conveyor 32 moves an article 16 in a straight line (right to left in FIG. 1), which passes through the detection and interrogation zone 12. An entrance side and an exit size of the detection and interrogation zone 12 are thus defined for the article 16, as is a side through which one or more interrogation devices 18 can interrogate one or more times for one or more observable (i.e. physical) properties of the detection and interrogation zone 12. Detection of the article 16 by a proximity sensor 14 in the detection and interrogation zone 12 determines the time and space coordinates of the article 16. These coordinates can be useful in downstream processes involving the article 16.

It can be desirable to determine the height of an article 16 on a conveyor 32 for one or more downstream processes, for example, sorting or labeling the article 16 based on height. In the embodiment of the present invention shown in FIG. 1, one or more proximity sensors 14 and one or more interrogation devices 18 are at rest relative to a conveyor frame (not shown) used to support the conveyor 32, and the article 16 is at rest relative to the conveyor 32, which is in motion at a fixed rate relative to the one or more proximity sensors 14 and the one or more interrogation devices 18. The present system and methods enable the automatic sizing of the article 16 by the one or more interrogation devices 18, whether the article 16 is in motion or at rest relative to the one or more proximity sensors 14 and the one or more interrogation devices 18 during measurement.

In one embodiment of the present invention, the at least one proximity sensor 14 is a reflective electromagnetic sensor, or “photon eye.” Such sensors are relatively reliable and inexpensive, and they can operate in a convenient wavelength range, for example, a band that includes wavelengths in a region generally known as the near-infrared. Such sensors typically comprise a transmitter, a reflector and a receiver, which together can be used to detect a “target” (e.g. an article 16) within the range of the detector. In the present context, this range can include a portion of a detection and interrogation zone 12 through which the article 16 will pass. The target is detected when it obstructs the radiation path of the photoelectric sensor and thus reduces the reflected signal and photon flux at the receiver relative to an obstruction-free radiation path.

Detection of an article 16 by at least one proximity sensor 14 can be used to trigger one or more interrogation devices 18. In one embodiment of the present invention, the one or more interrogation devices 18 can be used to interrogate a detection and imaging zone 12 one or more times for one or more observable properties. The results of the at least one interrogation can be used to determine the height of the article 16. The one or more interrogation devices 18 can be configured for measuring distance. The distance measurement can be primarily optical in nature, and the optical nature can be primarily active in character. One or more of the interrogation devices 18 can be a camera, which can be configured for its optical axis 181 to be perpendicular to the plane of the conveyor 30 and pass through the detection and interrogation zone 12, as in FIG. 2.

In one embodiment of the present invention, one or more of the interrogation devices 18 can be a three-dimensional time-of-flight camera. Each such camera can be configured for its field of view to include a detection and interrogation zone 12, so that when a target (e.g. an article 16) is present, each camera can sample an array of points simultaneously on the target surface. Each such camera can further be configured for collecting data in response to a signal from a proximity sensor 14 that has detected the target (e.g. the article 16). Sampling of points on the target surface involves light pulses emitted by a source, often an array of special light-emitting diodes in an illumination unit of a camera used for sampling. A lens of the camera then gathers reflected light and focuses it onto sensors inside the camera in the focal plane of the lens, e.g. an array of photodiodes. Measurement of the time of flight of the reflected light can be combined with other information to calculate the distance of objects (e.g. the article 16) in the field of view of the camera from its focal plane.

The time required for a photon to travel from a source to a target will depend on distance. In the embodiment of the present invention shown in FIG. 2, if at least one interrogation device 18 is a time-of-flight camera, two relevant distances will be from an article 16 to the focal plane of the lens of the camera 18, the distance 42, and from a conveyor 32 to the focal plane of the lens of the camera 18, the distance 40 plus the distance 42. The speed of light is a universal constant, close to 300,000 km/s. This will make the time of flight for a target 3 m away from the source and sensor array about 20 ns. A so-called t-zero measurement will involve a direct capture of a photon pulse routed from the source to a sensor array in the focal plane of the camera. The time of flight measured for objects in the field of view (e.g. article 16 and conveyor 32) and the t-zero measurement can be used to calculate time differences for the objects and the respective distances from the sensor array to the objects. The light pulses emitted by the source can have a width of 10 ns in one embodiment of the present invention, and the entire illumination and image capture process can take less than 1 μs. Such cameras can capture images at a framerate of over 100 Hz. For comparison, for a conveyor rate of 1 m/s, an article will move a distance of 1 μm in a time interval of 1 μs, about 100 times less than the width of a human hair, and 1 cm in 0.01 s, a representative time period of image capture. Data captured by a three-dimensional, time-of-flight camera (e.g. an interrogation device 18) can be used to calculate the height of an article 16 relative to a conveyor 30, which can be used for various downstream processes.

An interrogation device 18 of the present invention can send the results of one or more interrogations for observable properties of a detection and interrogation zone 12 to a processor 24 for real time or near-real time data analysis. In one embodiment of the present method, the interrogation device 18 can be a three-dimensional time-of-flight camera. The results of the one or more interrogations of the detection and interrogation zone 12 can contain time-of-flight information. The time-of-flight information can pertain to one or more targets in the detection and interrogation zone 12 (e.g. an article 16 and a conveyor 32). The real time or near-real time image processing of the one or more images can result in the determination of the shortest distance between a sensor array of the interrogation device 18 used to interrogate the detection and interrogation zone 12 and a first target (e.g. the article 16, the distance 42) and the shortest distance between the sensor array of the interrogation device 18 and a second target (e.g. the conveyor 32, the sum of the distances 40 and 42). From these data the height of the first article (the distance 40) can be calculated by subtraction. Height data thus determined can be used for diverse purposes, for example, the labeling and/or sorting of the article 16.

Singulated articles can be sorted in a process based on one or more physical properties of the articles, for example, height. In an embodiment of the present invention, if the height 40 of an article 16 on a conveyor 32 exceeds a predetermined minimum value in a binary sortation process, the article 16 can be diverted from the path of the conveyor 32, whereas if the height 40 of the article 16 on the conveyor 32 does not exceed the predetermined minimum value, the article 16 can remain on the path of the conveyor 32. In an embodiment of the present invention the article 16 can be one of a train of singulated articles of limited width and length but otherwise arbitrary size, shape and orientation. Height-based sortation of such articles can be used to achieve a variety of downstream purposes, for example, increasing the uniformity of mass distribution over a volume of a large container in an automated filling process or improving the utilization of a space in a fixed volume.

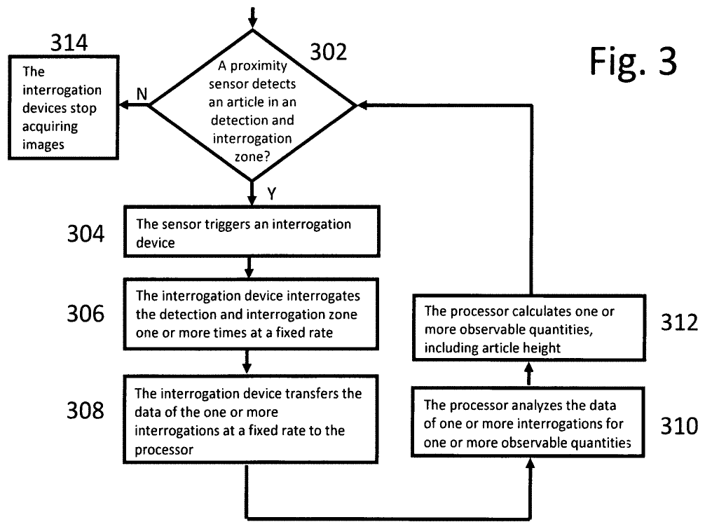

Referring to FIG. 3, the present method of sizing an article of arbitrary size, shape and orientation includes, at step 302, a first of one or more proximity sensors 14 detecting a first article 16 in a detection and interrogation zone 12. The article 16 can be brought to the detection and interrogation zone 12 by a conveyor 32. The nature of detection will depend on the type of proximity sensor. In one embodiment of the present method, the proximity sensor is an electromagnetic sensor, and detection occurs when an object, a “target,” breaks the optical path between an emitter of electromagnetic waves associated with the sensor and a reflector of the same waves.

At step 304 of the present method, the proximity sensor 14 triggers a first of one or more interrogation devices 18.

At step 306, the interrogation device 18 interrogates one or more times for one or more observable properties the detection and interrogation zone 12.

At Step 308, the Interrogation Device 18 Transfers the Data Acquired in the at Least One Interrogation to a Processor 24.

At step 310, the processor 24 analyzes the data of the at least one interrogation.

At step 312, the processor 24 calculates one or more quantities of interest based on the analyzed data, at least one of which is the height 40 of the article 16 in the detection and interrogation zone 12.

The method then returns to step 302. If the same article 16 is targeted by a second proximity sensor 14, steps 304-310 are repeated. In this case, a second interrogation device 18 interrogates the detection and interrogation zone 12 one or more times, and the results are sent to the processor 24. Otherwise, at step 314, the method ends and the first article 16 leaves the detection and interrogation zone 12. The conveyor 32 can now bring a second article 16 into the detection and interrogation zone 12. The method then begins anew at step 302.

Accurate article height information can be used to control an article labeling process in the case of a moving article. The process can involve, for instance, a print and apply device, and the labels can be adhesive labels. The process can also require specifying a first time, when an electromechanical label applicator arm (e.g. label applicator arm 38) of a labeling system must be actuated and extended from a location in the vicinity of (e.g. directly above) a conveyor (e.g. conveyor 32), and a second time, when the same label applicator arm should be retracted to its original position, so that the label applicator arm will apply a label to the surface of an article (e.g. the upper side of a cuboidal article 16) on the conveyor (e.g. conveyor 32) as the article is conveyed to the labeling system (e.g. labeling device 36) and the label applicator arm will not become damaged in the process (e.g. by being overextended). Specifying the first and second times for label applicator arm movement will require an accurate measure of the height (e.g. distance 40) of the article (e.g. article 16), the rate of motion of the conveyor (e.g. conveyor 32), and the rate of motion of the label applicator arm (e.g. label applicator arm 38). The article labeling process described here could occur downstream of an article sizing process.

Referring to the embodiment of the present invention shown in FIGS. 1 and 2, the system 10 of the present invention includes one or more labeling devices 36, at least one electromechanical label applicator arm 38 attached to each of the one or more labeling devices 36, a controller 28 of the labeling devices 36, a processor 24, a conveyor 32, and electrical communications cables 26 and 30. A large black arrow indicates that, in the embodiments shown, the conveyor 32 moves an article 16 of arbitrary size, shape and orientation in a direction 34 (from right to left; for convenience, the +x-direction) toward the labeling device 36. The processor 24 makes use of data on the rate of the conveyor 32, the height 40 and the position of the article 16 on the conveyor 32 to determine when to signal the controller 28. The controller 28 receives a signal from the processor 24 and commands the labeling device 36 to extend and retract the electromechanical label applicator arm 38 at specified times. The positions 16a-d of the article 16 on the conveyor 32 correspond to the positions 38a-d of the label applicator arm 38 at successive time points. For example, when the article 16 is at position a, the label applicator arm 38 is also at position a. When the article 16 reaches position d, the label applicator arm 38 also reaches position d, whereupon the label applicator arm 38 makes physical contact with the article 16 and labels it, regardless of its size, shape and orientation. The label applicator arm 38 is then retracted and returned to its original position.

A time interval Δt is required for a conveyor 32 to move an article 16 from a first location x₁ at a time point t₁ to a second location x₂ at a time point t₂, where t₂>t₁. In one embodiment of the present invention, x₁ can correspond to a location in space where one or more proximity sensors 14 are configured to detect an article 16 in relation to a detection and interrogation zone 12, and x₂ can correspond to a location in space where a label applicator arm 38 extends from a labeling device 36 and applies a label to the article 16. It is assumed that both the one or more proximity sensors 14 and the labeling device 36 are at rest in the same reference frame. In FIG. 2 the distance x₂−x₁=Δx is the distance 46. The time interval Δt=t₂−t₁ is readily calculated if the speed vₓ of the conveyor 32 is known. In symbols, Δt=Δx/vₓ. The time point t₂ is thus determined as t₁+Δx/vₓ. If t₁=0, then t₂=Δx/vₓ. This quantity will often be fixed and known, because Δx and vₓ will often be fixed and known.

A value for t₂ can enable calculation of the time point tₐ when a label applicator arm 38 should be actuated so that it will make physical contact with the surface of an article 16 in the vicinity of a labeling device 36 and thus enable productive labeling of the article 16. Suppose it is desired to apply a label to the upper side of the article 16, that is, the side that is farthest from a conveyor 32, as in FIG. 1. The calculation will depend on the rate of motion v_{z} of the label applicator arm 38 and the height 40 of the article 16, which will correspond to the desired extension length Δz of the label applicator arm 38 (distance 44 in FIG. 2) at the moment when the article 16 passes by the labeling device 36 on a conveyor 32. The time required for the label applicator arm 38 to extend the length Δz will be t₂−tₐ=Δz/v_{z}, from which tₐ=t₂−Δz/v_{z}=Δx/vₓ−Δz/v_{z} when t₁=0. No label can be applied to the article 16 unless 0<tₐ<t₂. (The choice of a vertical distance Δz for the extension of a label applicator arm 38 is arbitrary. An arm could instead extend a horizontal distance Δy, where the y-axis is perpendicular to the x-axis, and achieve a similar outcome. In this case, it would be necessary to know not the height 40 but the width of the article 16.)

Some practical considerations are worth noting. If vₐ is time-dependent, as will generally be the case, Δz/Δt will be variable. One will in this case need the functional form of Δz(t) to specify tₐ. Further, tₐ>t₁+t_{d}, where the delay time t_{d} is the minimum time needed to interrogate for one or more properties of the detection and interrogation zone 12 when the one or more proximity sensors 14 detects an article 16 therein, transfer the interrogation data obtained to the processor 24, calculate the height 40 of the article 16, signal the controller 28 to command the labeling device 36 to actuate the label applicator arm 38, and actuate the label applicator arm 38. The present disclosure provides a system and methods for sizing and labeling articles still or moving, regardless of the spacing between singulated articles on a conveyor, provided that the time criteria noted herein are met.

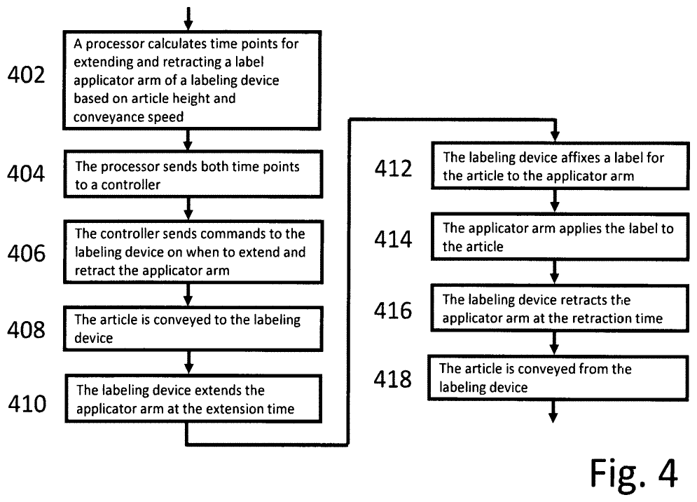

Referring to FIG. 4, the present method of labeling an article 16 of arbitrary size, shape and orientation includes, at step 402, a processor 24 calculating time points for extending and retracting an electromechanical label applicator arm 38 of a labeling device 36 based on article height 40 and a conveyance speed in the direction 34.

At step 404, the processor 24 sends the time points to a controller 28.

At step 406, the controller 28 sends commands to the labeling device 36 on when to extend and retract the label applicator arm 38.

At step 408, the article 16 is conveyed to the labeling device 36.

At step 410, the labeling device 36 extends the label applicator arm 38 at the extension time.

At step 412, the labeling device 36 affixes a label for the article 16 to the label applicator arm 38.

At step 414, the label applicator arm 38 applies the label to the article 16.

At step 416, the labeling device 36 retracts the label applicator arm 38 at the retraction time.

At step 418, the article 16 is conveyed from the labeling device 36.

A conveyor 32 can be used to convey the article 16 into the vicinity of the labeling device 36 for labeling by the label applicator arm 38, and the conveyor 32 can be used to move the article 16 away from the labeling device 36 after the labeling process is complete.

As used herein, ‘arbitrary orientation’ means “any attitude of an article relative to a size interrogation device used to image its optical, machine-readable representation of data.” The article 16 can be a box, flat, softpack or other type of item.

‘Arbitrary shape and size’ means “any volume of any shape, provided that it is at once large enough to accommodate the entire area of a label on which a complete, standard-sized optical, machine-readable representation of data can be printed and small enough for a portion of an entity on which an optical, machine-readable representation of data is displayed to pass through the sensing and imaging zone.”

‘Height’ means “the highest altitude of an article relative to the altitude of a support on which the article is at rest, measured as the difference between the shortest distance from the interrogation device to the support in the detection and interrogation zone and the shortest distance from the interrogation device to the article in the detection and interrogation zone.”

‘High-speed camera’ means “a certain kind of optical device that can capture and transfer at least one high-resolution frame in a time interval corresponding to the rate of motion of the article in the field of view of an optical device used to determine the height of an article on a conveyor.”

‘Interrogate’ means ‘to assay for a specific type of information.”

‘Interrogation device’ means “an electronic instrument that provides a specific type of information about a subject, for example, an information retrieval system that displays data about the subject upon inquiry.” The interrogation device can be a kind of camera. The subject of the interrogation can be a region of space or an object in the field of view of the camera.

‘Label’ means “a small piece of paper, plastic, or similar material attached to an article giving written, printed or graphic information, typically, about the article.” The information displayed on a label can comprise a unique article identifier.

‘Labeling device’ means “an apparatus for applying a label, usually adhesive, to an article.”

‘Moving article’ means “an article in motion relative to interrogation devices and proximity sensors.”

‘Optical device’ means “a device the function of which is based on electromagnetic radiation in the visible range.” An optical distance-measuring system is “active” if it illuminates the target during interrogation. Illumination generally involves some combination of monochromatic, polychromatic, continuous, pulsed, modulated, structured, polarized, coherent or partly-coherent light.

‘Processor’ means “one or more components in a computer responsible for receiving input data, executing the instructions of one or more computer programs by performing basic arithmetic logical, control and input/output operations specified by the instructions, and carrying out related functions.”

‘Proximity sensor’ means “a device that can detect the presence of a nearby article, often within 10 meters of the device.” The proximity sensor of the present machine vision method can be an electromagnetic sensor that operates in the IR or some other kind of sensor, for example, an ultrasound sensor.

‘Support’ means “a platform, whether still or moving, that bears all of the weight of an article.”

‘Target’ means “an article detected by a change of signal received by a proximity sensor, for instance, a change in reflected sound waves received in the case of an ultrasonic sensor or a change in reflected electromagnetic waves received in the case of a photonic sensor.”

‘Three-dimensional’ means “three dimensions of space, for example, length, width and height in a Cartesian coordinate system.”

‘Time-of-flight camera’ means “a range imaging camera that determines distance for each point of an image captured by the camera based on the known and constant speed of light.”

‘Unique item identifier (UII)’ means “a unique data string assigned to a single tangible article to distinguish the article from another article that may be of the same make and model.” A UII is often encoded in a two-dimensional bar code and physically marked on a tangible article, for example, by means of an adhesive label. The label applied by labeling device 36 can include a UII.

Many additional modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within.

The foregoing is provided for illustrative and exemplary purposes; the present invention is not necessarily limited thereto. Rather, those skilled in the art will appreciate that various modifications, as well as adaptations to particular circumstances, are possible within the scope of the invention as herein shown and described.

What is claimed is:

1. A system for the automatic sizing and labeling of an article of arbitrary size, shape and orientation, whether still or moving, the system comprising:
an interrogation system configured for:
capturing one or more sets of interrogation data pertaining to the article; and
sending the data pertaining to the article to a processor;
a processor configured for:
receiving the captured data from the interrogation system;
calculating physical properties of the article based on the received data; and
sending corresponding data pertaining to the article to a labeling system; and
a labeling system configured for:
receiving the corresponding data pertaining to the article from the processor; and
applying a label to the surface of the article.

2. The system of claim 1, wherein the interrogation system further includes:
a detection and interrogation zone defined by a predetermined volume;
one or more proximity sensors configured for detecting the article at one or more locations in the detection and interrogation zone; and
one or more interrogation devices configured for interrogating for physical properties of the detection and imaging zone upon detection of the article;
wherein each proximity sensor is configured for detecting the article independent of the other proximity sensors and triggering a respective interrogation device; and
wherein each interrogation device is configured for interrogating one or more times for one or more predetermined physical properties of the detection and interrogation zone when the article is located therein.

3. The system of claim 2, wherein the detection and interrogation zone is cuboidal in shape, and its six sides include an entrance side, an exit side and at least one side through which an interrogation device interrogates for observable properties of the detection and imaging zone.

4. The system of claim 2, wherein the at least one proximity sensor is one or more of an electromagnetic sensor, an ultrasonic sensor, a weight sensor, a thermal sensor or a combination thereof.

5. The system of claim 2, wherein the at least one interrogation device is configured to interrogate one or more times for one or more physical properties of the detection and interrogation zone sequentially in time at a predetermined rate, and the at least one interrogation device has temporary data storage capacity.

6. The system of claim 2, wherein at least one of the one or more interrogation devices is positioned above the detection and interrogation zone and is configured for measuring distance, the means of measuring distance being primarily optical in nature, the optical nature being primarily active in character, and the active, optical device enabling distance measurement based on a direct or an indirect measurement of photon time of flight.

7. The system of claim 2, wherein the system further includes one or more data processors incorporated into the one or more interrogation devices.

8. The system of claim 2, wherein the connections between the at least one proximity sensor and the at least one interrogation device are wired connections, wireless connections, or a combination thereof.

9. The system of claim 1, wherein the processor is configured to analyze one or more sets of interrogation data pertaining to the article, calculate one or more physical quantities, including the height of the article, and send a signal to the controller related to the height and rate of motion of the article.

10. The system of claim 1, wherein the labeling system further includes:
a controller configured for receiving signals from the processor and sending commands to one or more labeling devices; and
one or more labeling devices configured for actuating an electromechanical label applicator arm based on commands receiving from the controller;
wherein the label applicator arm is configured to extend at a first specified time and to retract at a second specified time, the first and second specified times being determined by the height and rate of motion of the article.

11. The system of claim 1, wherein the connections between the interrogation system, the processor and the labeling system are wired connections, wireless connections, or a combination thereof.

12. A method for the automatic sizing of an article of arbitrary size, shape and orientation, the method comprising:
conveying the article through an entrance side of a detection and interrogation zone;
detecting the article in the detection and interrogation zone by one or more proximity sensors;
triggering one or more respective interrogation devices by the one or more proximity sensors;
interrogating one or more times for one or more predetermined observable properties of the detection and interrogation zone by the one or more interrogation devices;
transferring the results of the one or more interrogations to a processor;
analyzing the results of the one or more interrogations with the processor; and
calculating from the results one or more physical properties pertaining to the article.

13. The method of claim 12, where the article is conveyed to or through the detection and imaging zone by any convenient means.

14. The method of claim 12, wherein one or more of the proximity sensors is one or more of an electromagnetic sensor, an ultrasound sensor, a weight sensor and a heat sensor.

15. The method of claim 12, wherein one or more of the interrogation devices is a three-dimensional time-of-flight camera.

16. The method of claim 12, wherein at least one of the predetermined properties of the detection and interrogation zone to be interrogated is the shortest distance from the interrogation device to the article in the detection and interrogation zone.

17. The method of claim 12, wherein at least one of the calculated physical properties of the article is height in standard units of length.

18. A method for the automatic labeling of an article of arbitrary size, shape and orientation, the method comprising:
calculating by a processor a first time point for extending an electromechanical label applicator arm and a second time point for retracting a label applicator arm of a labeling device based on article height and a conveyance speed;
sending both time points from the processor to a controller;
sending commands from the controller to the labeling device, indicating the time points for extending and retracting the label applicator arm;
conveying the article to the labeling device at the conveyance speed;
affixing a label for the article to the label applicator arm;
extending the label applicator arm at the extension time;
applying the label to the article; and
retracting the label applicator arm at the retraction time.

19. The method of claim 18, wherein the article can be labeled by any of one or more labeling devices.
